(19) United States
(12) Patent Application Publication
(10) Pub. No.: US 2004/0093792 A1
(43) Pub. Date: May 20, 2004

(54) Plant support system

(76) Inventor: Thomas R. Avery, Auburn, NY (US)

Correspondence Address: MICHAEL P. WILLIAMS, BOND, SCHOENECK & KING, PLLC, ONE LINCOLN CENTER, SYRACUSE, NY, 13202, US

(21) Appl. No.: 10/300,297

(22) Filed: Nov. 20, 2002

(51) Int. Cl. A01G 17/06; A01G 17/14

(52) U.S. Cl. 47/47

(57) ABSTRACT

A system for supporting plants that include an angle member and a vertical member. The angle member further includes a first end, a second end, a top side and a bottom side. The angle member allows a plant vine to grow from the second end to the first end with the vine intercrossing between the top side and the bottom side. The vertical member further includes a top end and a bottom end. The vertical member positions the angle member. The first end communicates with the top end to provide an appropriate angle of inclination of the angle member. This allows freely hanging produce from the vine. The bottom end communicates with a raised bed a lateral distance from the second end providing stability of the system. Finally, the second end communicates with the raised bed providing stability of the system and allowing the angle member close contact with the plant growing from the raised bed.

### FIELD OF THE INVENTION

This present invention relates to plant trellis and, more particularly, to a support structure and system for vine-like plants which produce fruit or vegetables that can be easily harvested when they are free hanging.

### BACKGROUND OF THE INVENTION

There are many structures and systems for the support of plants. The various combinations of poles, slats, cords and wires, as well as metal, concrete and wood structures are currently in use. Some structures are heavy, cumbersome and are expensive to produce. Some are temporary structures intended to be used for only a short period of time.

The trellis described in U.S. Pat. No. 6,378,245 B1 entitled “Versatile Trellis Kit” to Summers, is confined to a T-shaped support structure with hooks for hanging a net. While the trellis supports plants off the ground, the vertical structure is difficult to assemble and does not allow for easy harvesting of the plant's fruit or vegetable. The plant's fruit or vegetable are not free hanging and touch the trellis. Consequently, the plant grows around the fruit or vegetable.

The vine support described in U.S. Pat. No. 6,434,883 B1 entitled “Vine Support With Snap-in Cross Arm” to Hilmar, consists of a vertical post with a slotted aperture and cross arm, wherein wire is carried by the cross arm to support the vine. Although the vine support structure is less labor intensive to install at the farm-site over the prior art, its assembly requires a lot of pieces to snap-fit together. This structure is complicated to assembly. Over time the snap-fit connections become loose and eventually the snap-fit connections will fail. Consequently, the vine support structure cannot withstand mechanical or manual harvesting over long periods of time.

The tomato plant support described in U.S. Pat. No. 4,026,068 entitled “Support For A Tomato Plant” to Tepper, is confined to the use of plural upright members in surrounding relation about the plant with lateral members extending from the upright members. Although the tomato plant support allows growth of the plant without manually moving the vine as it grows, mechanical or manual harvesting of the tomato is difficult. The upright members are positioned vertically so as not to allow the tomato to hang freely. As the tomato plant grows the tomato can become entangled within the support structure and the vines of the tomato plant.

The support structure in U.S. Pat. No. 5,913,477 entitled “Modular Plant Support and Irrigation System” to Dean, is confined to a structure with interlocking tubes, connectors and planar hubs forming a module. Although the structure is aesthetically pleasing with different architectural designs, the structure does not allow for mechanical or manual harvesting of free hanging fruits or vegetables. The interlocking tubes , connectors and planar hubs, along with the various architectural designs makes the structure difficult to assemble. Further, the assembly of the structure is time consuming.

What is needed is a plant support system that allows the fruit or vegetable to hang so that it can be easily harvested. What is further needed is a plant support system that is simple to install and inexpensive to build.

### SUMMARY OF THE INVENTION

It is an aspect of the present invention to provide a plant support system to allow growing produce from vine-like plants to hang freely from the plant support for ease in harvesting the produce.

It is another aspect of the present invention to provide a plant support system that is inexpensive and easy to assemble.

These and other aspects of this invention are apparent in a system for supporting plant vines that includes an angle member and a vertical member. The angle member further includes a first end, a second end, a top side and a bottom side. The angle member allows a plant vine to grow from the second end to the first end with the vine intercrossing between the top side and the bottom side. The vertical member further includes a top end and a bottom end. The vertical member positions the angle member. The first end communicates with the top end to provide an appropriate angle of inclination of the angle member. This allows freely hanging produce from the vine. The bottom end communicates with a raised bed a lateral distance from the second end providing stability of the system. Finally, the second end communicates with the raised bed providing stability of the system and allowing the angle member close contact with the plant growing from the raised bed.

### BRIEF DESCRIPTION OF THE DRAWINGS

FIG. 1 illustrates the cross-section of a plant support structure and system in the preferred embodiment of the invention.

FIG. 2 illustrates a top view of the angle member in the preferred embodiment of the invention.

FIG. 3 illustrates the cross-section of a plant support structure and system with fruit hanging from the structure in the preferred embodiment of the invention.

FIG. 4 illustrates an isometric view of the plant support structure and system in the preferred embodiment of the invention.

FIG. 5 illustrates a detail of the top support post in the preferred embodiment of the invention.

FIG. 6 illustrates a detail of a hinge connection in the preferred embodiment of the invention.

### DETAILED DESCRIPTION OF THE INVENTION

While the present invention is described below with reference to a plant support system, a practitioner in the art will recognize the principles of the present invention are applicable elsewhere. For example, the plant support structure and system can be adapted to grow hanging flowers.

FIG. 1 illustrates a plant support structure 10 that includes a vertical member 11 and an angle member 12. The angle member 12 further includes a first end 19, a second end 22, a top side 21 and a bottom side 20. The vertical member 11 has a top end 18 and a bottom end 23. The angle member 12 is constructed to allow a plant-vine 13 to grow from the second end 22 to the first end 19 by the plant-vine 13 intercrossing between the angle member top side 21 and the angle member bottom side 20. The vertical member 11 positions the angle member 12 to allow freely hanging produce from the plant-vine 13 as the plant-vine grows and intercrosses between the top side 21 and the bottom side 20 of the angle member 12.

The first end 19 communicates with the top end 18 to provide an appropriate angle of inclination 17 of the angle member 12. The proper angle of inclination 17 allows for the easy harvesting of the produce that grows on the plant-vine 13. For example, when the angle of inclination 17 is appropriate the produce will hang freely from the angle member 12 so as the sides of the produce do not touch the bottom side 20. If the angle of inclination 17 is too great, the produce may not freely hang because the sides of the produce will touch the vertical member 11. Also, it is more difficult to harvest the produce because the produce is hanging from the plant-vine 13 too close to the ground 16. If the angle of inclination is too small, the produce will not freely hang because the side of the produce will touch the bottom side 20 of the angle member 12 and the plant-vine 13 will grow around the produce. When the produce touches the bottom side 20 it is more difficult to harvest the produce because the produce becomes entangled in the plant-vine 13.

The bottom end 23 communicates with the raised bed 14 a lateral distance 24 from the second end 22 providing stability of the structure 10 and accessibility to the produce. The proper lateral distance 24 assists in determining the angle of inclination 17. The bottom end 23 communicates with the raised bed 14 a lateral distance 24 from the second end 22 providing additional stability for the structure 10. This allows close contact between the plant-vine 13 and the angle member 12. Once the second end 22 has been anchored 22a into the raised bed 14 near the plant-vine 13 the proper lateral distance 24 is established and the bottom end 23 is anchored 23a. The first end 19 of the angle member is secured to the top end of the vertical member 12 by a connector 25.

The vertical member 11 of the structure 10 is any element that can properly support the angle member 12. The element used in the preferred embodiment of the invention is rebar of a size to vertically support the weight of the angle member. For example, in a 350 foot row of 234 tomato plants set 18 inches apart 47, ⅝″φ rebar would be used to support twenty three (23) angle members 12 that are each 52″ by 16′. The rebar would be approximately 5′ in length and spaced about 7.5′ apart. Other vertical members 11 include, but are not limited to, stakes, angle iron, pipe, wood, poles and the like. The vertical member 11 is constructed of steel when rebar is used in the preferred embodiment of the invention. As is known by the practitioner in the art, the vertical member 11 steel is substitutable for wood, plastic, iron or any material that is capable of repeated uses during growing seasons in succeeding years of the plant-vine 13. Finally, the vertical member 11 bottom end anchor 23a is any device that allows the vertical member 11 to be easily positioned and secured into the ground 16 such as a stake and the like.

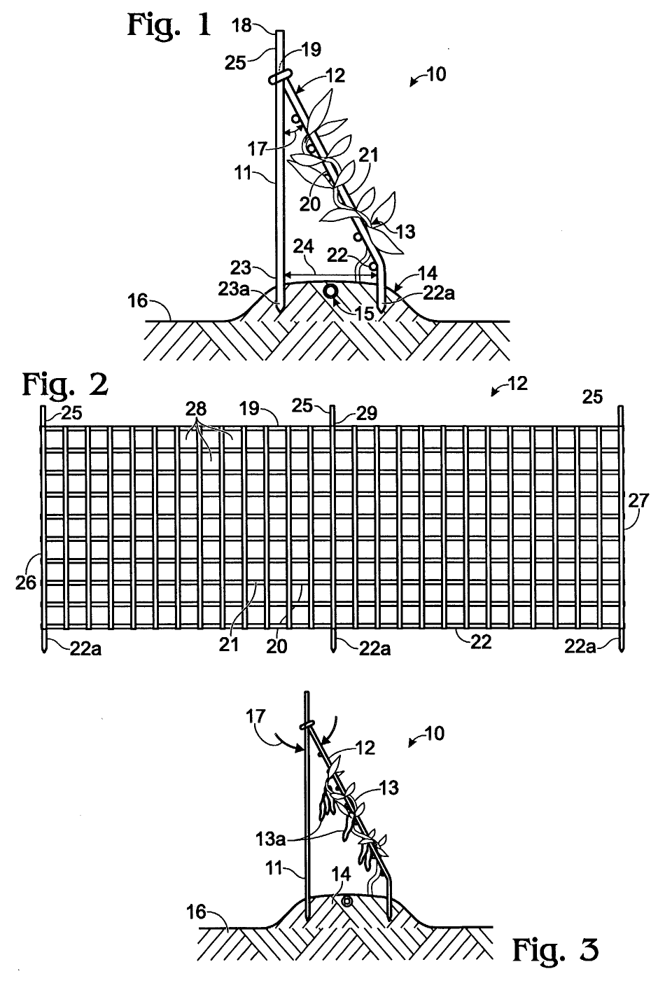

FIG. 2 illustrates the angle member 12 used in the preferred embodiment of the invention. The angle member 12 is constructed in a vertical series of lattice cells 28 between the first end 19 and the second end 22 and horizontal series of lattice cells 28 between the third end 26 and the fourth end 27. Each individual lattice cell 28 open space is a different area with the area depending upon the type of plant-vine 13 that is grown. For example, a tomato plant will use an individual lattice cell 28 that is about 6″ by 6″. In the preferred embodiment of the invention, an angle member 12 with an overall dimension of 16′ by 52″ contains about two hundred fifty six (256) lattice cells 28 that are each 6″ by 6″. The 6″ by 6″ cell is substitutable for a variety of lattice cell 28 open space (area) depending on the plant-vine 13 to be grown. The angle member 12 may contain any number of lattice cells 28 when there are different overall dimensions of the angle member 12. The 6″ by 6″ cell is substitutable for a variety of cells including, but not limited to, 1″ by 1″, 1″ by 2″, 2″ by 2″, 3″ by 5″ or any combination of size lattice cell 28 to adequately handle the kind of plant-vine 13 to be grown. Also, the angle member 12 has numerous lattice cells depending on the combination of the angle member 12 overall dimension size and the lattice cell 28 opening size. Finally, the angle member 12 overall dimension size and lattice cell 28 opening size (area) depend upon the type of plant-vine 13 to be grown.

The angle member 12 and lattice cells 28 are constructed from wood as the material that is used in the preferred embodiment of the invention. However, wood is substitutable for other materials including, but not limited to, plastic, steel, aluminum and the like. A series of horizontal strips 28a (FIG. 5) of material and a series of vertical strips 28b (FIG. 5) of material are positioned to form the lattice cell 28 openings. The number and length of horizontal strips and vertical strips depend upon the angle member 12 overall dimension size and the size of each individual lattice cell 28 opening. For example a 52″ by 16′ angle member 12 panel with 6″ by 6″ lattice cells will contain two hundred fifty six (256) lattice cells. This angle member 12 will contain 144 LF of horizontal strips and 132 LF of vertical strips. As is known by the practitioner in the art, an angle member 12 with a different overall dimension size and lattice size will contain a different amount of horizontal and vertical strips. Alternately, a 3″ by 3″ lattice cell 28 in an angle member 12 with an overall dimension of 52″ by 16′ will contain five hundred twelve (512) lattice cells 28. Furthermore, the angle member 12 lattice cell 28 horizontal strips 28a and vertical strips 28b are substitutable for different methods of lattice cell construction including wire mesh, mesh netting, horizontal/vertical strips of wire, modular cells, rope mesh and the like.

The connector stub 25 extends outward from the first end 19 for a distance that allows the angle member 12 to be secured to the vertical member 11. After the second end anchor 22a and the bottom end anchor 23a are secured into the raised bed 14, the connector stub 25 is positioned and secured to the vertical member 11. The connector stub is positioned at a location between the top end 18 and the bottom end 23 on the vertical member 11 that provides for the proper angle of inclination 17. The connector stub 25 is secured to the vertical member 11 by a mechanical connection that consists of tightly wrapping wire around the connector stub 25 and the vertical member 11 after the connector stub 25 communicates with the vertical member 11 at the desired location. As is known by the practitioner in the art, wire is substitutable for wire rope, rope, tape, bolts, screws, fasteners and the like.

In another embodiment, the first end 19 connector stub 25 are hingeably connected. This allows the structure 10 to be folded, that is, the vertical member 11 can be moved and positioned so as the length of the vertical member 11 touches the bottom side 20 of the angle member 12. Typically, there would be three vertical members 11 hingeably connected to one angle member 12 with an overall dimension of 52″ by 16′. The vertical members would be located at the third end 26 connector stub 25, the middle 29 connector stub 25 and the fourth end 27 connector stub 25. As is known by the practitioner in the art, the hingeable connection is a variety of different connections using bolts, rods, flexible connections, such as rubber ties, and the like.

As the plant vine 13 (FIG. 1) grows the vine will intercross between the top side 21 and the bottom side 20 of the angle member 12 through the lattice cell 28 open spaces (FIG. 2). This is accomplished by using the irrigation system 15 to provide moisture to the plant-vine 13. As the plant-vine 13 grows the produce will freely hang from the bottom side 20 of the angle member 12 to eventually be easily harvested.

FIG. 3 illustrates the cross-section of the plant support structure 10 located at the ground 16 in the preferred embodiment of the invention. The vertical member 11 supports the angle member 12 at the appropriate angle of inclination 17 so that the plant-vine 13 growing from the raised bed 14 will bear produce 13a that is exposed for easy harvesting.

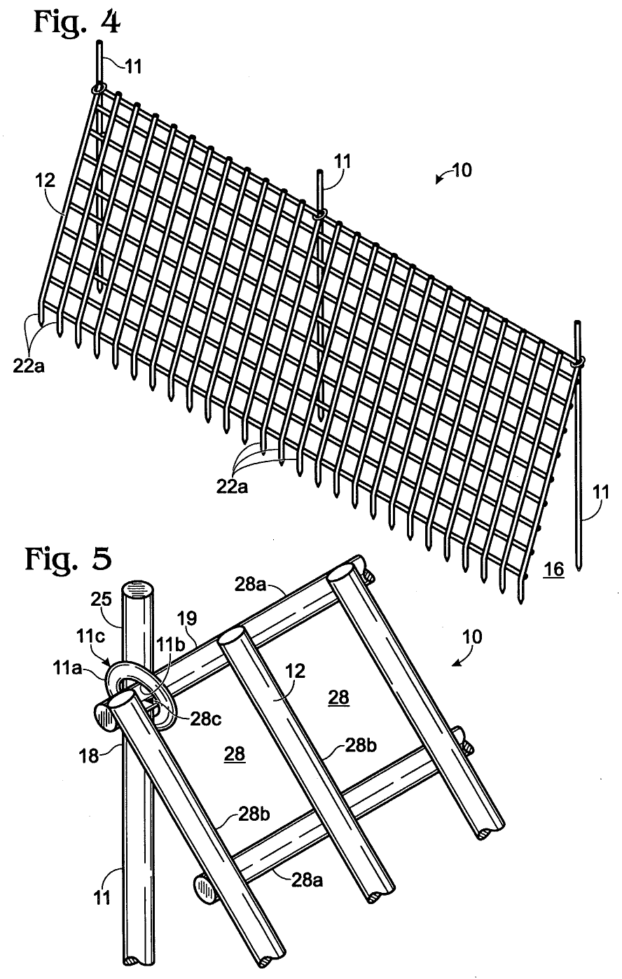

FIG. 4 illustrates the plant support structure 10 in an isometric view of the preferred embodiment of the invention. The plant support structure is located at the ground 16 with the vertical member 11 positioned into the ground 16. The angle member 12 communicates with the vertical member 11 by a connector stub 25. The angle member 12 communicates with the ground 16 through a plurality of second end anchors 22a.

FIG. 5 shows the plant support structure 10 in a detailed view of the communication between the vertical member 11 and the angle member 12. The vertical member 11 top end 18 is hingeably connected to a ring connector 11a. The first end 19 and the stub connector 25 of the angle member are positioned on the inside portion 11b of the ring connector 11a. The ring connector 11a can be any piece of material formed so that inside portion 11b is a diameter that is about 50%-80% the diameter of the outside portion 11c. This allows the vertical member 11 to swing freely around the stub connector 25 and the horizontal strip 28a. Typically, the lattice cell 28 horizontal strip 28a of material and the lattice cell 28 vertical strip 28b of material are hingeably connected at 28c after a horizontal strip 28a and a vertical strip 28b are positioned on the inside portion 11b of the ring connector 1a.

Referring back to FIGS. 1 through 5, the plant support structure 10 can be scaled to function as a planting system for a small garden. The vertical element 11 would consist of two vertical members 11, rods or rebar, for mounting an angle member 12 that would be about 26″ by 8′. If the lattice cells 28 were 6″ by 6″ the number of lattice cells 28 would be sixty four (64) when using the dimension of 26″ by 8′ for the angle member 12. As previously discussed, the angle member is similarly constructed and secured into the ground 16. Alternately, the one piece angle member 12 is dividable into a two-piece angle member 12, wherein the two pieces are hingeably connected. This would allow the angle member 12 to be folded and unfolded for easier installation in a small garden.

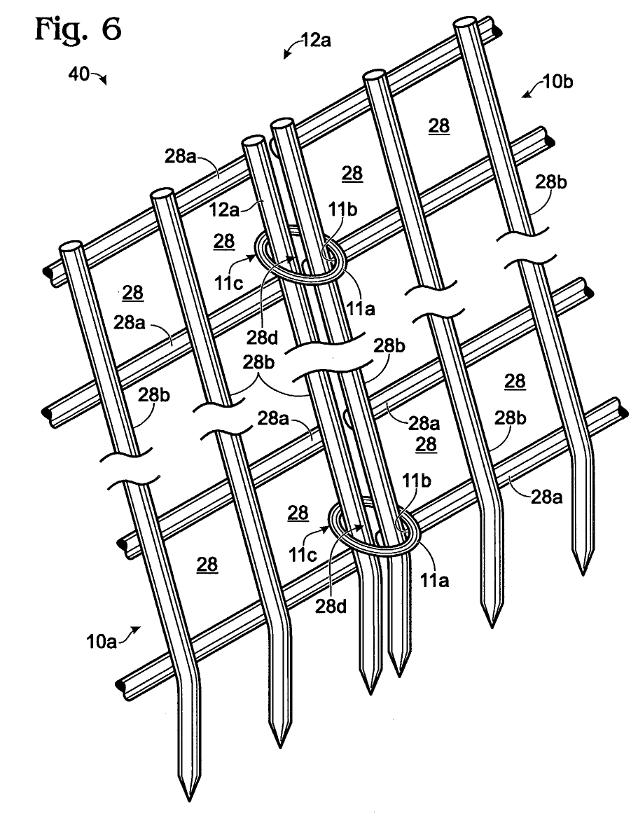

FIG. 6 illustrates a hinged connection to fold the plant support structure 40. The foldable plant support structure 40 consists of a first piece 10a and a second piece 10b comprising the angle member 12a. For example, the overall dimension of 52″ by 8′ of the angle member 12 will consist of a first piece 10a that has an overall dimension of 52″ by 4′ and a second piece 10b that has an overall dimension of 52″ by 4′. The first piece 10a is hingeably connected to the second piece 10b by using three ring connectors 11a placed an equal distance along the first piece 10a vertical strip 28b and the second piece 10b vertical strip 28b. Alternately, the three connector rings 11a are substitutable for two, four or as many as are needed depending on the dimension of the first piece 10a and the second piece 10b. The first piece 10a vertical strip 28b and the second piece 10b vertical strip 28b are positioned on the inside portion 11b of the ring connector 11 a. The ring connector 11a can be any piece of material formed so that inside portion 11b is a diameter that is about 50%-80% the diameter of the outside portion 11c. This allows the first piece 10a and the second piece 10b to swing freely around each other which provides easy folding of the plant support structure 10. Typically, the first piece 10a vertical strip 28b and the second piece 10b vertical strip 28b are hingeably connected at 28d after the vertical strips 28b are positioned on the inside portion 11b of the ring connector 11a.

While there has been illustrated and described what is at present considered to be the preferred embodiment of the invention, it will be appreciated that numerous changes and modifications are likely to occur to those skilled in the art. It is intended in the appended claims to cover all those changes and modifications that fall within the spirit and scope of the present invention.

What is claimed is:

1. A system for supporting plant vines in a raised bed comprising:
a) an angle member with a first end, a second end, a top side and a bottom side, said angle member constructed for allowing the plant vine to grow from said second end to said first end, the plant vine intercrossing between said top and bottom side;
b) a vertical member with a top end and a bottom end, said vertical member for positioning said angle member;
c) said first end communicates with said top end for providing an appropriate angle of inclination of said angle member, whereby produce from the plant vine hang freely;
d) said bottom end communicates with a raised bed a lateral distance from said second end providing stability of the system; and
e) said second end communicates with the raised bed for providing stability of the system and allowing said angle member close contact with the plant vine growing from the raised bed.

2. The system as claimed in claim 1, wherein said angle member further consists of a plurality of lattice cells.

3. The system as claimed in claim 2, wherein said lattice cells are formed by a series of horizontal and vertical strips.

4. The system as claimed in claim 1, wherein said communication of said first end and said top end further consists of a ring connector.

5. The system as claimed in claim 1, wherein said structure further consists of a first piece hingeably connected to a second piece.
